(19) United States
(12) Patent Application Publication
(10) Pub. No.: US 2026/0168242 A1
(43) Pub. Date: Jun. 18, 2026

(54) CONNECTING STRUCTURE BETWEEN WALL PANELS AND WALL PANEL ASSEMMBLY

(71) Applicant: Zhejiang Shedex Industrial and Trading Co., Ltd., Wuyi (CN)

(72) Inventor: Feihong XU, Jinhua City (CN)

(21) Appl. No.: 19/031,618

(22) Filed: Jan. 18, 2025

(30) Foreign Application Priority Data
Dec. 16, 2024 (CN) 202423102235X
Dec. 16, 2024 (CN) 2024231022222
Dec. 16, 2024 (CN) 2024231022275
Dec. 16, 2024 (CN) 2024231022294
Dec. 16, 2024 (CN) 2024231022326

(51) Int. Cl. E04C 2/30; E04C 2/00; F16B 5/00

(52) U.S. Cl. CPC E04C 2/30; F16B 5/0012; E04C 2002/004

(57) ABSTRACT

A connecting structure between wall panels and a wall panel assembly are provided in the disclosure, and the connecting structure includes a first connecting bar and a second connecting bar which are detachably connected with each other, and the first connecting bar and the second connecting bar are respectively provided with a first lock tongue and a second lock tongue which are clamped with each other. The first connecting bar is provided with a first mounting hole, and the second connecting bar is provided with a second connecting hole at a position corresponding to the first mounting hole. The connecting structure further includes a threaded connector, and the threaded connector passes through the first mounting hole and the second mounting hole respectively to connect and fix the first connecting bar and the second connecting bar.

### CROSS REFERENCE TO RELATED APPLICATIONS

This application claims priority of Chinese Patent Application No. 2024231022222 entitled “REINFORCING STRUCTURE OF TOOLSHED” filed on Dec. 16, 2024, Chinese Patent Application No. 2024231022275 entitled “CONNECTING STRUCTURE BETWEEN WALL PANELS” filed on Dec. 16, 2024, Chinese Patent Application No. 2024231022326 entitled “CONNECTING STRUCTURE OF BOTTOM PLATE AND WALL PANEL” filed on Dec. 16, 2024, Chinese Patent Application No. 2024231022294 entitled “FULLY ASSEMBLED STORAGE ROOM” filed on Dec. 16, 2024, and Chinese Patent Application No. 202423102235X entitled “WALL-CORNER CONNECTING STRUCTURE” filed on Dec. 16, 2024, which are incorporated herein by reference.

### TECHNICAL FIELD

The disclosure relates to the technical field of toolsheds, in particular to a connecting structure between wall panels and a wall panel assembly.

### BACKGROUND ART

A toolshed is generally provided in outdoor places such as gardens, which is mainly used to store tools that need to be used at work and used as places where employees need to have a rest for drinking water, cool and relieve summer heat after busy work.

Currently, some toolsheds are made of assembling materials, which are convenient to use, can be built quickly, and are very convenient to transport and move. However, in an assembled toolshed, most of wall panels are not integrally formed, and the wall panels are connected one by one. Every two wall panels are connected with a support frame respectively and then fixed, and overall connection strength depends on the support frame, with low connection strength and complicated connection operations.

### SUMMARY

Object of the disclosure: an object of the disclosure is to provide a connecting structure between wall panels, which solves a problem of unstable connection between wall panels in a toolshed.

Solution:

A connecting structure between wall panels includes a first connecting bar and a second connecting bar which are detachably connected with each other, and the first connecting bar and the second connecting bar are respectively provided with a first lock tongue and a second lock tongue which are clamped with each other. The first connecting bar is provided with a first mounting hole, and the second connecting bar is provided with a second connecting hole at a position corresponding to the first mounting hole. The connecting structure further includes a threaded connector, and the threaded connector passes through the first mounting hole and the second mounting hole respectively to connect and fix the first connecting bar and the second connecting bar.

Optionally, the first lock tongue includes an embedding block and the second lock tongue includes an embedding groove, and when the first lock tongue and the second lock tongue are clamped with each other, the embedding block is clamped into the embedding groove.

A wall panel assembly is further provided in the disclosure, which includes a main body. A first connecting bar and a second connecting bar which are detachably connected with each other are respectively provided at corresponding positions on opposite sides of the main body, and the first connecting bar and the second connecting bar are respectively provided with a first lock tongue and a second lock tongue which are clamped with each other. The first connecting bar is provided with a first mounting hole, and the second connecting bar is provided with a second connecting hole at a position corresponding to the first mounting hole. The connecting structure further includes a threaded connector, and the threaded connector passes through the first mounting hole and the second mounting hole respectively to connect and fix the first connecting bar and the second connecting bar.

Optionally, one of the first mounting hole and the second mounting hole is penetrated, and the other of the first mounting hole and the second mounting hole is not penetrated.

Optionally, a clamping groove is provided at a side of the main body provided with the penetrated mounting hole, and the clamping groove is located between the first connecting bar or the second connecting bar and the main body, and the clamping groove is configured to connect frameworks.

Optionally, an extension bar is connected with an upper end of the main body, and the extension bar is configured to be connected with a wall top.

Optionally, a plurality of clamping blocks are provided at a lower end face of the main body, and the plurality of clamping blocks are configured to be connected with a floor.

Optionally, a plurality of positioning grooves are provide at an end face of the main body provided with the penetrated mounting hole.

Optionally, a guiding groove is provided at an end face of the main body, and the guiding groove and the plurality of positioning grooves are respectively located at two sides of the main body.

Optionally, extension directions of the guiding groove and the clamping groove are the same as extension directions of the first connecting bar and the second connecting bar.

Beneficial effect: a clamping operation is realized through connecting parts at two sides of the main body, which exhibits convenient mounting, clear positioning, and easier assembling and disassembling. After the clamping is completed, the first connecting bar and the second connecting bar can be further connected by the threaded connector using added mounting holes so as to improve connection strength, and the framework can be further connected at the mounting holes, so that connection strength between wall panels is improved; and the framework is mounted after two wall panels are connected, with more convenient connection and mounting.

### BRIEF DESCRIPTION OF THE DRAWINGS

FIG. 1 is a schematic view of an overall structure according to the disclosure;

FIG. 2 is a schematic structural rear view according to the disclosure;

FIG. 3 is a schematic structural view of a local section of a joint according to the disclosure;

FIG. 4 is an enlarged structural schematic view at B in FIG. 1;

FIG. 5 is an enlarged schematic structural view at A in FIG. 2;

FIG. 6 is a schematic view of a framework according to the disclosure

FIG. 7 is an enlarged schematic structural view at C in FIG. 6; and

FIG. 8 is a schematic view of the framework according to the disclosure.

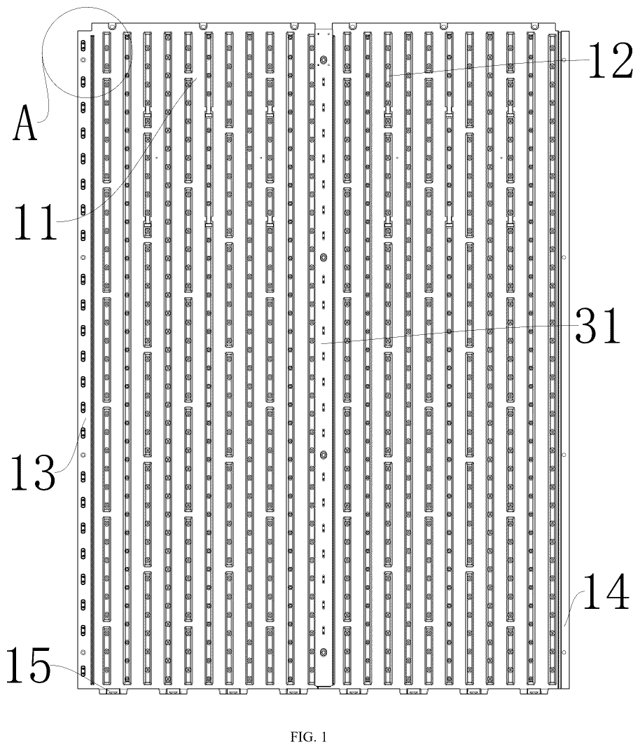

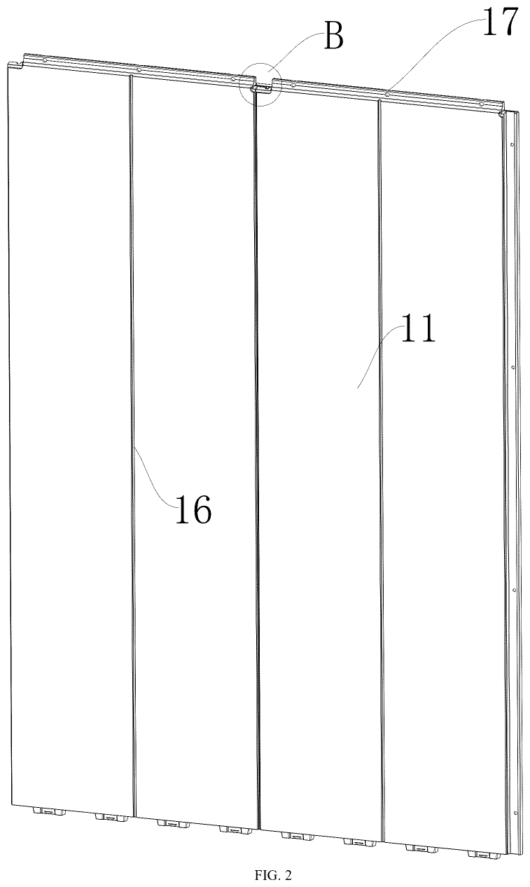

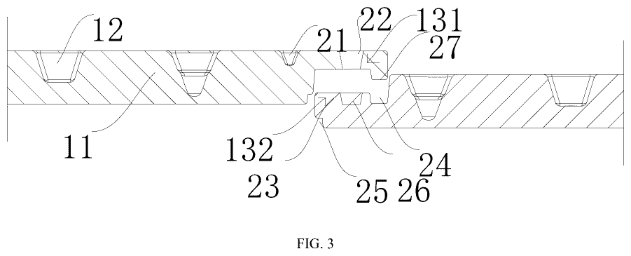

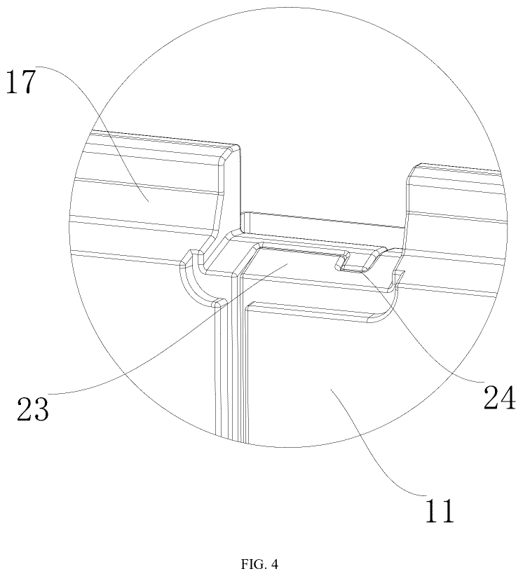

Reference numerals: 11. Main Body; 12. Positioning Groove; 13. First Connecting Bar; 14. Second Connecting Bar; 15. Clamping Block; 16. Guiding Groove; 17. Extension Bar; 21. Clamping Groove; 22. Mounting Hole; 23. Embedding Block; 24. Embedding Groove.

### DETAILED DESCRIPTION

In order to make technical schemes of the disclosure more clear, the disclosure will be further explained in detail in the following in combination with drawings and specific examples.

### Embodiment 1

A connecting structure is provided in this embodiment, which includes a first connecting bar 13 and a second connecting bar 14 which are detachably connected with each other, and the first connecting bar and the second connecting bar are respectively provided with a first lock tongue 131 and a second lock tongue 132 which are clamped with each other. The first connecting bar is provided with a first mounting hole 22, and the second connecting bar is provided with a second connecting hole 26 at a position corresponding to the first mounting hole. The connecting structure further includes a threaded connector (not shown), and the threaded connector passes through the first mounting hole and the second mounting hole respectively to connect and fix the first connecting bar and the second connecting bar.

The first lock tongue includes an embedding block 27 and the second lock tongue includes an embedding groove 24, and when the first lock tongue and the second lock tongue are clamped with each other, the embedding block is clamped into the embedding groove. For convenience of clamping and dismounting, a notch 25 is formed after the first embedding block is clamped into the first embedding groove. In order to further improve clamping effect, a second embedding block 23 is provided at a side of the embedding groove, and correspondingly, a second embedding groove matched with the second embedding block is provided at a side of the embedding block. An embedding depth of the first embedding block is greater than an embedding depth of the second embedding groove, and directions of the first embedding groove and the second embedding groove are opposite to each other, for example one of the first embedding groove and the second embedding groove is recessed upward and the other of the first embedding groove and the second embedding groove is recessed downward, so as to facilitate transverse splicing of the two lock tongues.

A wall panel assembly is further provided, which includes a main body 11. The main body 11 is a wall panel, and adjacent main bodies 11 are connected with each other.

A connecting part for connecting adjacent main bodies are respectively provided at two sides of the main body 11, and the upper and lower sides of the main body 11 are respectively connected with a top plate and a floor.

The connecting part includes a first connecting bar 13 and a second connecting bar 14. The first connecting bar 13 and the second connecting bar 14 can be arbitrarily mounted on both sides of the main body 11, but all of main bodies 11 have a same structure, which facilitates assembling and mounting.

The first connecting bar 13 and the second connecting bar 14 are detachably connected with each other, and both the first connecting bar 13 and the second connecting bar 14 are provided with a mounting hole 22. When the first connecting bar 13 and the second connecting bar 14 are clamped with each other, a bolt in threaded connection with both the first connecting bar 13 and the second connecting bar 14 is mounted at mounting holes 22. One of the mounting holes 22 provided in the first connecting bar 13 and the second connecting bar 14 is penetrated and the other of the mounting holes 22 is not penetrated. The unpenetrated mounting hole 22 is provided at an outer side of the wall panel, which can accommodate but not expose an end of the bolt, thus reducing a corrosion risk of the bolt.

There are a plurality of mounting holes 22, and the plurality of mounting holes 22 are arranged in an array, which facilitates improvement of connection strength between the first connecting bar 13 and the second connecting bar 14.

In this disclosure, the first connecting bar 13 and the second connecting bar 14 are clamped with each other, and the first connecting bar 13 and the second connecting bar 14 are complementary in structure, and respectively have a first embedding block or a second embedding block, the first embedding block or the second embedding block is connected with the main body 11, and an embedding groove is formed at a joint of the embedding block and the main body 11. When the first connecting bar 13 and the second connecting bar 14 are connected with each other, the embedding block is embedded in the embedding groove, so that connection between two adjacent main bodies 11 can be achieved through connection between the embedding block and the embedding groove.

The mounting hole 22 penetrates through the lock tongue, and a mounting hole 22 is provided on an end face of the embedding block 27, which facilitates mounting of the bolt.

In this embodiment, the first connecting bar 13 and the second connecting bar 14 are clamped at the end face through the embedding block and the embedding groove, and in another embodiment, the first connecting bar 13 or the secondary connecting bar 14 can be connected by inserting.

Meanwhile, a clamping groove 21 is provided at an end face of the main body 11, and the clamping groove 21 is located at a side of the first connecting bar 13 or the second connecting bar 14 and is located between the first connecting bar 13 or the second connecting bar 14 and the main body, and an extension direction of the clamping groove 21 is arranged to be parallel to extension directions of the first connecting bar 13 and the second connecting bar 14, and the clamping groove 21 is detachably connected with a framework 31 connected with the mounting hole 22. The framework is connected with the first connecting bar 13 and the second connecting bar 14 by bolts, and a width of the framework is larger than widths of the first connecting bar 13 and the second connecting bar 14. An extended clip or strip 34 is provided at both sides of the framework. When the framework is connected with the first connecting bar 13 and the second connecting bar 14, the strip at a side of the framework is clamped in the clamping groove 21, and the clip at the other side of the framework is clamped in an adjacent positioning groove 12, and there is no need to newly define a clamping groove to further connect the two adjacent main bodies, thus improving the strength.

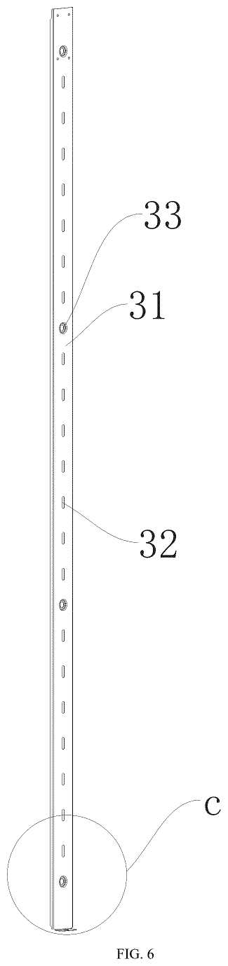

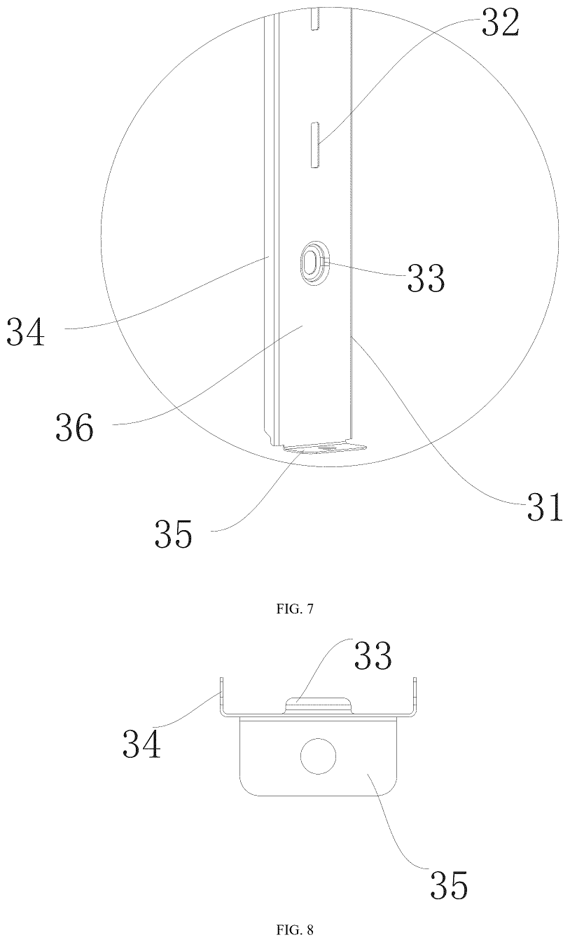

According to FIGS. 6-8, the framework 31 is in a vertical and long strip shape. The framework 31 includes a main framework body 36 at its center, and two relatively long sides of the main framework body 36 are fixedly connected with the strip 34, a length of the strip 34 is same as that of the main framework body 36, and the main framework body 36 is located at joints of the wall panels at both sides or in the middle of one wall panel.

Further, the main framework body and each of the wall panels are detachably connected with each other through a connecting part, and the connecting part is formed by protruding the main framework body to a side of a respective clamping part, and a matched wall panel with the connecting part can be provided with a corresponding groove, and a fixing hole 33 is provided on an protruding end face, and the fixing hole 33 is in a shape of a truncated cone, and the fixing hole 33 is located on a protrusion formed between two strips 34. When the framework 31 is mounted, the protrusion is abutted against the wall panel, and at this time, a certain gap is left between the main framework body 36 and the wall panel, and connection with the wall panel can be made at the fixing hole 33 by bolts.

A hanging hole 32 is provided on the end face of the main framework body 36, and the hanging hole 32 penetrates through the main framework body 36, and there are a plurality of hanging holes 32, and the plurality of hanging holes 32 are sequentially connected in array from top to bottom. Meanwhile, the fixing hole 33 is arranged among the hanging holes 32 at intervals, for example, one fixing hole is arranged every seven hanging holes, but the fixing hole 33 is arranged at positions closest to two ends of the main framework body 36, and a number of the hanging holes 32 is much larger than a number of the fixing holes 33. The hanging hole 32 is used for inserting a tray 35, and the tray 35 is connected with the hanging hole 32 by a bolt, and the tray 35 is located between two adjacent frameworks 31, and a number of trays 35 is adjusted according to user demands, which is easy to dismount.

A lower end of the framework 31 is connected with a floor. After the floor is connected with the wall panel 11, the lower end of the framework 31 is abutted against the floor. The lower end of the framework 31 is fixedly connected with a folding strip 35, and the folding strip 35 and the strips 34 are located at front and rear sides of the main framework body 36 respectively. When the framework 31 is connected with the wall panel 11, the folding strip 35 can be connected with the floor at this time. The folding strip 35 is provided with a through connecting hole, and a bolt passes through the connecting hole, thereby fixedly connecting the folding strip 35 to the floor.

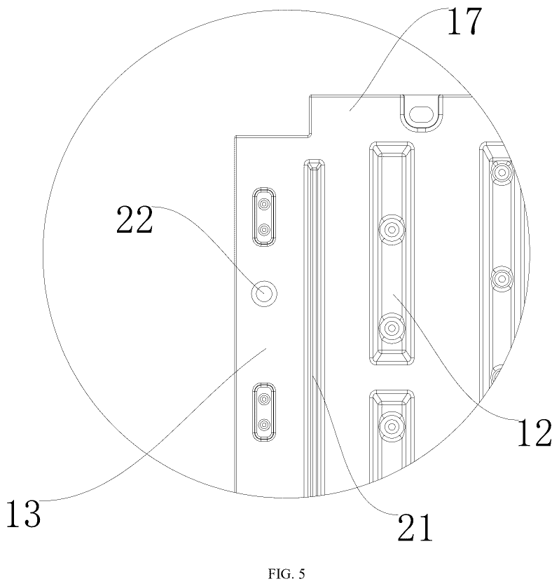

An extension bar 17 is fixedly connected with an upper end face of the main body 11, a thickness of the extension bar 17 is smaller than a thickness of the main body 11, and the extension bar 17 is configured to be connected with a top plate above. As shown in FIG. 5, in a width direction where the first lock tongue 131 and the second lock tongue 132 are provided, the extension bar 17 is not provided, that is, the extension bar 17 only extends from one side of the main body to the opposite other side.

A plurality of clamping blocks 15 at a lower end face of the main body 11, and the plurality of clamping blocks 15 are arranged in array and configured to be connected with the floor.

There are a plurality of positioning grooves 12 on the end face of the main body 11, and a screw hole is provided in each of the plurality of positioning grooves 12, which facilitates installing of the bolt and hanging or connecting of various tools.

A guiding groove 16 is further provided at the end face of the main body 11, and the guiding groove 16 is vertically arranged, and the guiding groove 16 is arranged at an outer side of the main body 11, while the positioning groove 12 is located at an inner side of the main body 11. The clamping groove 21 is also located at the inner side of the main body 11.

A cross section of the groove or hole in this embodiment is mostly trapezoidal in shape.

The above described embodiments only express several implementations of the present disclosure, and their descriptions are more specific and detailed, but they cannot be constructed as limiting a scope of the present disclosure. It should be noted that, several modifications and improvements can be made by those of ordinary skill in the art without departing from the concept of the present disclosure, which belong to the protection scope of the present disclosure. Therefore, the protection scope of this disclosure shall be subjected to appended claims.

1. A connecting structure between wall panels, comprising a first connecting bar and a second connecting bar which are detachably connected with each other, and the first connecting bar and the second connecting bar are respectively provided with a first lock tongue and a second lock tongue which are clamped with each other; the first connecting bar is provided with a first mounting hole, and the second connecting bar is provided with a second connecting hole at a position corresponding to the first mounting hole; and
the connecting structure further comprises a threaded connector, and the threaded connector passes through the first mounting hole and the second mounting hole respectively to connect and fix the first connecting bar and the second connecting bar.

2. The connecting structure between wall panels according to claim 1, wherein the first lock tongue comprises an embedding block and the second lock tongue comprises an embedding groove, and when the first lock tongue and the second lock tongue are clamped with each other, the embedding block is clamped into the embedding groove; and both the first mounting hole and the second mounting hole are respectively positioned on the first lock tongue or the second lock tongue.

3. A wall panel assembly, comprising a main body, wherein a first connecting bar and a second connecting bar which are detachably connected with each other are respectively provided at corresponding positions on opposite sides of the main body, and the first connecting bar and the second connecting bar are respectively provided with a first lock tongue and a second lock tongue which are clamped with each other; the first connecting bar is provided with a first mounting hole, and the second connecting bar is provided with a second connecting hole at a position corresponding to the first mounting hole; the connecting structure further comprises a threaded connector, and the threaded connector passes through the first mounting hole and the second mounting hole respectively to connect and fix the first connecting bar and the second connecting bar.

4. The wall panel assembly according to claim 3, wherein one of the first mounting hole and the second mounting hole is penetrated, and the other of the first mounting hole and the second mounting hole is not penetrated.

5. The wall panel assembly according to claim 3, wherein a clamping groove is provided at a side of the main body provided with the penetrated mounting hole, and the clamping groove is located between the first connecting bar or the second connecting bar and the main body, and the clamping groove is configured to connect frameworks.

6. The wall panel assembly according to claim 3, wherein an extension bar is connected with an upper end of the main body, and the extension bar is configured to be connected with a wall top.

7. The wall panel assembly according to claim 3, wherein a plurality of clamping blocks are provided at a lower end face of the main body, and the plurality of clamping blocks are configured to be connected with a floor.

8. The wall panel assembly according to claim 5, wherein a plurality of positioning grooves are provide at an end face of the main body provided with the penetrated mounting hole.

9. The wall panel assembly according to claim 8, wherein a guiding groove is provided at an end face of the main body, and the guiding groove and the plurality of positioning grooves are respectively located at two sides of the main body.

10. The wall panel assembly according to claim 9, wherein extension directions of the guiding groove and the clamping groove are the same as extension directions of the first connecting bar and the second connecting bar.
